(19) United States
(12) Patent Application Publication
(10) Pub. No.: US 2026/0357075 A1
(43) Pub. Date: Nov. 12, 2026

(54) ELECTROPHORETIC PARTICLE AND PREPARATION METHOD THEREFOR, MICROCAPSULE, AND ELECTRONIC INK SCREEN

(71) Applicant: Shanghai Tianma Microelectronics Co., Ltd., Shanghai (CN)

(72) Inventors: Jian Jin, Shanghai (CN); Yuanhao Feng, Shanghai (CN); Yuan Ding, Shanghai (CN); Feng Qin, Shanghai (CN)

(73) Assignee: Shanghai Tianma Microelectronics Co., Ltd., Shanghai (CN)

(21) Appl. No.: 19/699,002

(22) Filed: Jun. 5, 2026

(30) Foreign Application Priority Data
Nov. 12, 2025 (CN) 202511658730.5

(51) Int. Cl. C09C 1/36; C09D 11/52; G02F 1/167; G02F 1/16757

(52) U.S. Cl. CPC C09C 1/3684; C09D 11/52; G02F 1/167; G02F 1/16757; C01P 2004/04; C01P 2004/62; C01P 2004/64; C01P 2004/84

(57) ABSTRACT

Provided are an electrophoretic particle and a preparation method therefor, a microcapsule, and an electronic ink screen. The electrophoretic particle includes an inorganic nanoparticle as a core and a copolymer coating layer disposed on at least part of the surface of the core, where the copolymer coating layer is bonded to the inorganic nanoparticle via a covalent bond, and the copolymer has p structural units. The electrophoretic particle has good dispersion uniformity in a solvent and is resistant to agglomeration and sedimentation, thereby demonstrating excellent dispersion stability.

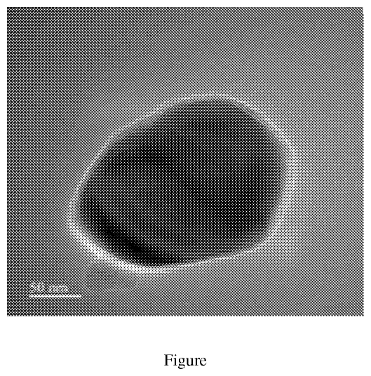

### CROSS-REFERENCE TO RELATED APPLICATION(S)

This application claims priority to Chinese Patent Application No. 202511658730.5 filed Nov. 12, 2025, the disclosure of which is incorporated herein by reference in its entirety.

### TECHNICAL FIELD

The present disclosure belongs to the field of electronic inks and, in particular, relates to an electrophoretic particle and a preparation method therefor, a microcapsule, and an electronic ink screen.

### BACKGROUND

Electrophoretic particles are a class of fine particles capable of directional migration under the influence of an electric field and have been widely used in fields such as electrophoretic display technology (for example, electronic paper), biomedical detection, and material separation. The core characteristic of the electrophoretic particles is the possession of an electrical charge or the ability to induce a polarity in an electric field, thereby enabling the electrophoretic particles to move in a specific direction under the driving of electric field forces. However, due to their poor dispersibility, which makes them prone to agglomeration and sedimentation, the electrophoretic particles are often required to be modified.

### SUMMARY

In view of deficiencies in the existing art, the object of the present disclosure is to provide an electrophoretic particle, a preparation method therefor, and use thereof.

To achieve the above object, the present disclosure adopts the following technical solutions.

In a first aspect, the present disclosure provides an electrophoretic particle. The electrophoretic particle includes an inorganic nanoparticle as a core and a copolymer coating layer disposed on at least part of the surface of the core. The copolymer coating layer is bonded to the inorganic nanoparticle via a covalent bond. The copolymer has p structural units represented by Formula I:

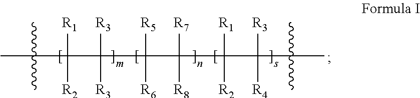

where
m+s>0, m×s=0, m and s are integers, n is a positive integer, and p≥1;
R₁ to R₄ include H, substituted or unsubstituted C1-C20 alkyl, or substituted or unsubstituted C1-C20 derivative alkyl, a group of the derivative includes an ester group or an ether group, and at least one of R₁ to R₄ contains a C8-C20 linear alkyl chain segment;
R₅ to R₈ include H, substituted or unsubstituted C1-C5 alkyl, substituted or unsubstituted C6-C20 alkylaryl, or substituted or unsubstituted C6-C20 derivative alkylaryl, a group of the derivative includes an ester group or an ether group, and at least one of R₅ to R₈ contains a C6-C20 aryl chain segment; and
“ [symbol] ” represents a linkage site.

In a second aspect, the present disclosure provides a method for preparing the electrophoretic particle described in the first aspect. The preparation method includes the following steps.

(1) An inorganic nanoparticle and a silane coupling agent are subjected to a coupling reaction to obtain an intermediate product.

(2) The intermediate product is subjected to a free radical copolymerization reaction with a first monomer and a second monomer to obtain the electrophoretic particle.

The first monomer carries R₁ to R₄ groups, and the second monomer carries R₅ to R₈ groups.

In a third aspect, the present disclosure provides a microcapsule. The microcapsule includes the electrophoretic particle described in the first aspect.

In a fourth aspect, the present disclosure provides an electronic ink screen. The electronic ink screen includes the electrophoretic particle described in the first aspect or the microcapsule described in the third aspect.

### BRIEF DESCRIPTION OF DRAWINGS

The FIGURE shows a TEM image of the electrophoretic particle obtained in Example 1 of the present disclosure.

### DETAILED DESCRIPTION

Technical solutions of the present disclosure are further described below through specific embodiments. It is to be understood by those skilled in the art that the examples are only intended to facilitate understanding of the present disclosure and are not to be construed as limiting the present disclosure.

Current preparation methods for electrophoretic particles typically achieve uniform dispersion in solvents by coating inorganic nanoparticles. However, existing coating modification methods still face issues such as entanglement and/or bridging on the surface of nanoparticles, thereby leading to agglomeration and sedimentation of the electrophoretic particles. Additionally, a low coating rate of the coating layer can also cause the electrophoretic particles to be prone to agglomeration and sedimentation. Based on this, the present disclosure provides an electrophoretic particle, a preparation method therefor, and use thereof. The electrophoretic particle has excellent dispersion uniformity and dispersion stability in the solvent. The specific details are as follows:

In a first aspect, the present disclosure provides an electrophoretic particle. The electrophoretic particle includes an inorganic nanoparticle as a core and a copolymer coating layer disposed on at least part of the surface of the core. The copolymer coating layer is bonded to the inorganic nanoparticle via a covalent bond. The copolymer has p structural units represented by Formula I:

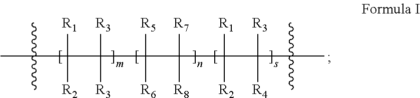

where
m+s>0, m×s=0, m and s are integers, n is a positive integer, and p≥1;
R₁ to R₄ include H, substituted or unsubstituted C1-C20 alkyl, or substituted or unsubstituted C1-C20 derivative alkyl, a group of the derivative includes an ester group or an ether group, and at least one of R₁ to R₄ contains a C8-C20 linear alkyl chain segment;
R₅ to R₈ include H, substituted or unsubstituted C1-C5 alkyl, substituted or unsubstituted C6-C20 alkylaryl, or substituted or unsubstituted C6-C20 derivative alkylaryl, a group of the derivative includes an ester group or an ether group, and at least one of R₅ to R₈ contains a C6-C20 aryl chain segment; and
“ [symbol] ” represents a linkage site.

The coating layer of the inorganic nanoparticle defined by the present disclosure contains both C8-C20 linear alkyl chain segments to enhance the wettability of the electrophoretic particles with the solvent and C6-C20 aryl chain segments to increase the steric hindrance of the coating layer, thereby avoiding entanglement and/or bridging between flexible molecular chains within the coating layer. Therefore, the electrophoretic particle provided by the present disclosure has excellent dispersion uniformity and dispersion stability.

In the present disclosure, one and only one of m and s is 0, while the other is a positive integer. That is, in the copolymer coating layer described in the present disclosure, either the structure carrying R₁ to R₄ groups is bonded to the inorganic nanoparticle via a chemical bond, or the structure carrying the R₅ to R₈ groups is bonded to the inorganic nanoparticle via a chemical bond.

In the present disclosure, the C1-C20 alkyl includes C1, C2, C3, C5, C8, C10, C12, C15, C18, C20, etc., alkyl.

In the present disclosure, the C1-C20 derivative alkyl includes C1, C2, C3, C5, C8, C10, C12, C15, C18, C20, etc., derivative alkyl.

In the present disclosure, the C1-C20 derivative alkyl refers to C1-C20 alkyl whose main chain structure carries a derivative group. The derivative group in the present disclosure may be an ester group or an ether group. For illustrative purposes, the present disclosure provides the following example. For example, ester-derived C10 alkyl may be —COO—(CH₂)₈—CH₃. The above structure is given only as an example; other structures such as —CH₂—COO—(CH₂)₇—CH₃ are also possible. The present disclosure will not elaborate further in detail.

In the present disclosure, the C8-C20 linear alkyl chain segment includes a C8, C9, C10, C12, C14, C15, C16, C18, C20, etc., linear alkyl chain segment.

In the copolymer coating layer provided by the present disclosure, the C8-C20 linear alkyl chain segment has a certain flexibility, which can reduce the density of the electrophoretic particles and enhance the wettability of the electrophoretic particles with the solvent, thereby enabling the electrophoretic particles to disperse more effectively in the solvent. The C8-C20 linear alkyl chain segment in the present disclosure refers to a segment where all 8-20 carbon atoms are located on the main chain without any branched structure.

In the present disclosure, the C1-C5 alkyl may be methyl, ethyl, propyl, isobutyl, n-butyl, etc.

In the present disclosure, the C6-C20 alkylaryl may be C6, C7, C8, C9, C10, C12, C14, C15, C16, C18, C20, etc., alkylaryl.

The alkylaryl in the present disclosure may be a structure where an alkyl group is linked to the main chain or a structure where an aryl group is linked to an alkyl group on the main chain. For example, C7 alkylaryl may be —CH₂-Ph (where Ph refers to phenyl) or -Ph-CH₃. The present disclosure does not impose excessive limitations herein; any group that satisfies the requirement of being C6-C20 alkylaryl can be applied in the present disclosure.

In the present disclosure, the C6-C20 derivative alkylaryl may be C6, C7, C8, C9, C10, C12, C14, C15, C16, C18, C20, etc., derivative alkylaryl.

In the present disclosure, the C6-C20 derivative alkylaryl refers to C6-C20 alkylaryl whose main chain structure carries a derivative group. The derivative group in the present disclosure may be an ester group or an ether group. For illustrative purposes, the present disclosure provides the following example. For example, ester-derived C10 alkylaryl may be —COO—CH₂-Ph-CH₂CH₃. The above structure is given only as an example; other structures such as —CH₂—COO—CH₂-Ph-CH₃ are also possible. The present disclosure will not elaborate further in detail.

In the present disclosure, one and only one of m and s is 0, while the other is a positive integer. When m=0, the structure carrying R₅ to R₈ groups in the copolymer coating layer is bonded to the inorganic nanoparticle via a chemical bond. When s=0, the structure carrying R₁ to R₄ groups in the copolymer coating layer is bonded to the inorganic nanoparticle via a chemical bond. In some embodiments of the present disclosure, s=0 can enable the electrophoretic particle to have excellent dispersion uniformity and dispersion stability.

In some embodiments of the present disclosure, s=0.

In some embodiments of the present disclosure, p=1.

In the present disclosure, when p=1, the copolymer coating layer is a block copolymer coating layer. Moreover, if s=0, the structure carrying R₁ to R₄ groups in the block copolymer coating layer is bonded to the inorganic nanoparticle via a chemical bond. In this manner, the electrophoretic particle provided by the present disclosure has excellent dispersion uniformity and dispersion stability.

In some embodiments of the present disclosure, m>n.

In some embodiments of the present disclosure, 6:4≤m:n≤8:2. M:n may be 6:4, 6.5:3.5, 7:3, 7.5:2.5, 8:2, etc.

In the present disclosure, based on the sum of m and n being 100%, the percentage of m is 60%-80%, for example, 60%, 62%, 65%, 68%, 70%, 72%, 75%, 78%, 80%, etc.

In the present disclosure, by defining the ratio of m to n in the copolymer, the electrophoretic particle provided by the present disclosure can achieve both excellent dispersion uniformity and stable dispersion stability. If the content of flexible chains introduced is too high, the flexible chains within the coating layer are prone to entanglement/bridging during mutual collisions in the application of the electrophoretic particle, thereby leading to agglomeration and sedimentation of the electrophoretic particle during application and reducing the stability and reliability of the electrophoretic particle. If the content of flexible chains is too low, the wettability of the electrophoretic particle with the solvent deteriorates, thereby resulting in poor dispersion uniformity of the electrophoretic particle and making the electrophoretic particle prone to agglomeration.

In some embodiments of the present disclosure, m:n=7:3.

In some embodiments of the present disclosure, any three of R₁ to R₄ are selected from H or C1-C4 alkyl, and only one of the three is C1-C4 alkyl, where the C1-C4 alkyl may be methyl, ethyl, n-propyl, isopropyl, n-butyl or isobutyl.

In some embodiments of the present disclosure, any one of R₁ to R₄ is —(CH₂)ₓ—COO—(CH₂)_{y}—CH₃, where x is selected from an integer of 0 to 4, for example, 0, 1, 2, 3, or 4, and y is selected from an integer of 7 to 19, for example, 7, 8, 9, 10, 11, 12, 13, 14, 15, 16, 17, 18, or 19.

In some embodiments of the present disclosure, R₁ and R₂ are H, R₃ is-CH₃, and R₄ is —COO—(CH₂)₁₁—CH₃.

In some embodiments of the present disclosure, any three of R₅ to R₈ are selected from H or C1-C4 alkyl, and only one of the three is C1-C4 alkyl, where the C1-C4 alkyl may be methyl, ethyl, n-propyl, isopropyl, n-butyl or isobutyl.

In some embodiments of the present disclosure, any one of R₅ to R₈ is —C₆H₅ or —(CH₂)_{c}—COO—R₉, where c is selected from an integer of 0 to 4, for example, 0, 1, 2, 3, or 4, R₉ is selected from substituted or unsubstituted C6-C20 alkylaryl, for example, C6, C7, C8, C9, C10, C12, C14, C15, C16, C18, C20, etc., alkylaryl, and a substituted group includes a hydroxyl group, a carboxyl group, an alkyl group or an alkoxy group.

In some embodiments of the present disclosure, R₅ and R₆ are H, R₇ is —CH₃, and R₈ is —C₆H₅ or —COO—CH₂—CH(OH)—C₆H₄—R, where R is selected from H, —CH₃, —OCH₃ or —O—(CH₂)₆—CH₃.

In some embodiments of the present disclosure, R₈ is —COO—CH₂—CH(OH)—C₆H₄—R, where R is selected from H, —CH₃, —OCH₃ or —O—(CH₂)₆—CH₃.

In some embodiments of the present disclosure, the copolymer is a diblock copolymer which has the following structure:

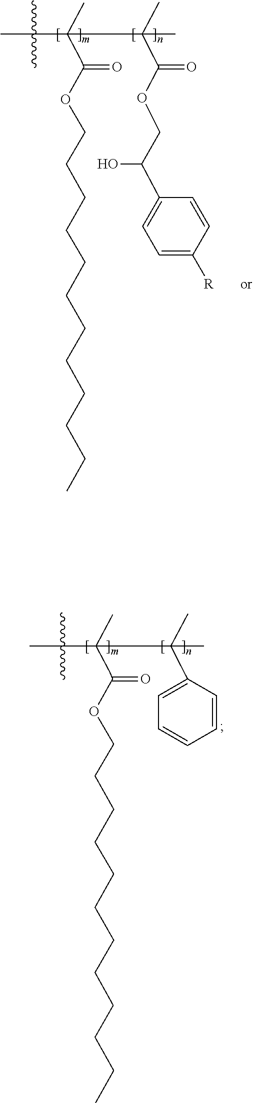

where R is H, —CH₃, —OCH₃, or —O—(CH₂)₆—CH₃.

6:4≤m:n≤8:2. Optionally, m:n=7:3. The ratio of m to n makes the relative molecular weight of the copolymer between 1000 and 200000.

In some embodiments of the present disclosure, the relative molecular weight of the copolymer is 1000-200000, for example, 1000, 5000, 10000, 20000, 50000, 80000, 100000, 120000, 150000, 180000, 200000, etc.

The relative molecular weight of the copolymer according to the present disclosure is tested by the cross-linked polystyrene column (CPG) test method.

In some embodiments of the present disclosure, the coating rate of the copolymer coating layer on the core is >99.9%.

The coating rate of the copolymer coating layer included in the electrophoretic particle provided by the present disclosure basically reaches 100%, exhibiting a fully coated state, thereby avoiding the drawback that agglomeration and sedimentation still occur after the modification and coating of inorganic nanoparticles and enabling the electrophoretic particle to have excellent dispersion uniformity.

In some embodiments of the present disclosure, the inorganic nanoparticle includes any one or a combination of at least two of titanium dioxide, zirconium oxide, zinc oxide, antimony trioxide or silicon dioxide, optionally, titanium dioxide.

In some embodiments of the present disclosure, the inorganic nanoparticle has a particle diameter of 50-1000 nm, for example, 50 nm, 100 nm, 150 nm, 200 nm, 300 nm, 400 nm, 500 nm, 600 nm, 700 nm, 800 nm, 900 nm, 1000 nm, etc.

The particle diameter of the inorganic nanoparticle in the present disclosure refers to the particle diameter of an individual nanoparticle, not the particle diameter of a nanoparticle agglomerate. In the present disclosure, the particle diameter of the inorganic nanoparticle is obtained through statistical analysis of transmission electron microscopy (TEM) images.

In a second aspect, the present disclosure provides a method for preparing the electrophoretic particle described in the first aspect. The preparation method includes the following steps.

(1) An inorganic nanoparticle and a silane coupling agent are subjected to a coupling reaction to obtain an intermediate product.

(2) The intermediate product is subjected to a free radical copolymerization reaction with a first monomer and a second monomer to obtain the electrophoretic particle.

The first monomer carries R₁ to R₄ groups, and the second monomer carries R₅ to R₈ groups.

In the present disclosure, the R₁ to R₄ groups and the R₅ to R₈ groups are as defined in the first aspect.

In some embodiments of the present disclosure, the initiator used for the free radical copolymerization reaction includes any one or a combination of at least two of azo compounds, organic peroxides, inorganic peroxides, or redox system initiators. In some embodiments of the present disclosure, the azo compounds include azobisisobutyronitrile (AIBN) and/or 2,2′-azobis(2-methylpropionamidine) dihydrochloride (AIBA), the organic peroxides include any one or a combination of at least two of benzoyl peroxide (BPO), percarbonates, or peroxyesters, the inorganic peroxides include persulfates, and the redox system initiators include any one or a combination of at least two of persulfate/sulfites, BPO/amines, or organic peroxides/metal ions.

In some embodiments of the present disclosure, the addition amount of the intermediate product is 15%-50% of the total mass of the first monomer and the second monomer, for example, 15%, 20%, 25%, 30%, 35%, 40%, 45%, 50%, etc.

In some embodiments of the present disclosure, the preparation method further includes step (3): a high-temperature aging treatment is performed after the free radical reaction. Optionally, the high-temperature aging treatment is performed at a temperature of 100-150 °C, for example, 100 °C, 105 °C, 110 °C, 115 °C, 120 °C, 125 °C, 130 °C, 135 °C, 140 °C, 145 °C, 150 °C, etc., for 48-96 h, for example, 48 h, 50 h, 55 h, 60 h, 65 h, 70 h, 75 h, 80 h, 85 h, 90 h, 95 h, 96 h, etc.

In the present disclosure, the high-temperature aging treatment is performed after the free radical copolymerization reaction is completed. During the high-temperature aging treatment, the C8-C20 linear alkyl contained in the flexible chain segments (repeating units carrying R₁ to R₄ groups) can fully extend, thereby allowing the flexible chain segments to disperse more effectively on the outer side of the inorganic nanoparticle while facilitating partial exposure of the rigid chain segments. Furthermore, the high-temperature aging treatment can remove impurities (by removing monomers, initiators, and solvents), strengthen the structure (by promoting cross-linking and increasing the cross-link density), eliminate defects (by relaxing stress, densifying the coating layer, and improving uniformity), and optimize interfaces (by enhancing adhesion to the particles and improving compatibility/dispersibility with external matrices), thereby resulting in a copolymer coating layer on the surface of the modified particles with a higher coating rate (exceeding 99.9%) and a more robust structure.

In the present disclosure, the copolymer included in the coating layer may be a random copolymer or a block copolymer, and the structure of the copolymer is related to the method for preparing an electrophoretic particle. The present disclosure also provides a method for preparing an electrophoretic particle, specifically as follows:

In some optional solutions of the present disclosure, the copolymer is a block copolymer, and the method for preparing an electrophoretic particle includes the following steps.

In S1, an inorganic nanoparticle and a silane coupling agent are subjected to a coupling reaction to obtain an intermediate product I.

In S2, the intermediate product I reacts with a first monomer carrying R₁ to R₄ groups to obtain an intermediate product II.

In S3, the intermediate product II reacts with a second monomer carrying R₅ to R₈ groups, and after the reaction is completed, a high-temperature aging treatment is performed to obtain the electrophoretic particle.

In the above preparation method, the block copolymer is synthesized by stepwise adding the reaction monomers and controlling the reaction temperature.

In the present disclosure, after the intermediate product II is prepared, the intermediate product II may be purified first to remove unnecessary residual reaction monomers, or the next raw materials may be directly fed without purification. The formation of the block copolymer coating layer is achieved through stepwise material feeding and temperature control. In some embodiments of the present disclosure, the option of directly feeding materials without purification may be chosen to reduce costs and meet the requirements for large-scale applications.

In some embodiments of the present disclosure, in step S2, the reaction is performed at a temperature of 60-100 °C, for example, 60 °C, 65 °C, 70 °C, 75 °C, 80 °C, 85 °C, 90 °C, 95 °C, 100 °C, etc., for 4-24 h, for example, 4 h, 8 h, 9 h, 10 h, 11 h, 12 h, 14 h, 15 h, 18 h, 20 h, 22 h, 24 h, etc.

In some embodiments of the present disclosure, in step S3, the reaction is performed at a temperature of 80-120 °C, for example, 80 °C, 85 °C, 90 °C, 95 °C, 100 °C, 105 °C, 110 °C, 115 °C, 120 °C, etc., for 12-24 h, for example, 12 h, 14 h, 16 h, 18 h, 20 h, 22 h, 24 h, etc.

In the present disclosure, the copolymer may also be a random copolymer. The random copolymer is prepared via a one-pot method. Specifically, in the present disclosure, the first monomer and the second monomer may be simultaneously added to the reaction system for reaction, and then the resulting copolymer is highly likely to be a random copolymer. Alternatively, after the first monomer and the second monomer are simultaneously added, the reaction temperature may be controlled to allow the first monomer to react preferentially over the second monomer. Under this condition, the resulting copolymer is more “ordered” while the possibility of forming a random copolymer still exists. In the present disclosure, optionally, a temperature-controlled reaction process following a single batch material feeding is adopted to prepare the electrophoretic particle.

In some embodiments of the present disclosure, the copolymer is a random copolymer, and the preparation method includes the following steps.
a. An inorganic nanoparticle and a silane coupling agent are subjected to a coupling reaction to obtain an intermediate product.
b. The intermediate product is subjected to a free radical copolymerization reaction with a first monomer carrying R₁ to R₄ groups and a second monomer carrying R₅ to R₈ groups, and after the reaction is completed, a high-temperature aging treatment is performed to obtain the electrophoretic particle.

In the above preparation method, the copolymer is prepared via a one-pot method. In step b, the free radical copolymerization reaction is performed at a temperature of 60-120 °C, for example, 60 °C, 70 °C, 80 °C, 90 °C, 100 °C, 110 °C, 120 °C, etc., for 6-24 h, for example, 6 h, 8 h, 10 h, 12 h, 15 h, 16 h, 18 h, 20 h, 22 h, 24 h, etc.

In some embodiments of the present disclosure, in step b, the reaction procedure of the free radical copolymerization reaction includes: the reaction is first performed at 60-80 °C (for example, 60 °C, 65 °C, 70 °C, 75 °C, 80 °C, etc.) for 8-24 h (for example, 8 h, 9 h, 10 h, 11 h, 12 h, 14 h, 15 h, 18 h, 20 h, 22 h, 24 h, etc.), and the reaction is performed at a raised temperature of 81-120 °C (for example, 81 °C, 85 °C, 90 °C, 95 °C, 100 °C, 105 °C, 110 °C, 115 °C, 120 °C, etc.) for 12-24 h (for example, 12 h, 14 h, 16 h, 18 h, 20 h, 22 h, 24 h, etc.).

In some embodiments of the present disclosure, the first monomer is selected from any one or a combination of at least two of lauryl (meth)acrylate, myristyl (meth)acrylate, cetyl (meth)acrylate, stearyl (meth)acrylate, 1-decene, or an olefin compound having 11-21 (for example, 11, 12, 13, 15, 16, 18, 20, 21, etc.) carbon atoms.

In some embodiments of the present disclosure, the second monomer is selected from styrene, methyl styrene, cinnamene, phenylbutenoid, vinylnaphthalene or benzyl methacrylate, or has a general structural formula represented by Formula II:

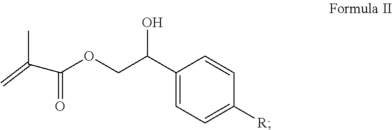

where R is selected from H, —CH₃, —OCH₃, or —O—(CH₂)₆—CH₃.

In some embodiments of the present disclosure, the molar amount of the first monomer accounts for 60%-80% of the total molar amount of the first monomer and the second monomer, for example, 60%, 62%, 65%, 68%, 70%, 72%, 75%, 78%, 80%, etc., optionally, 65%-75%.

In some embodiments of the present disclosure, the first monomer is selected from lauryl methacrylate.

In some embodiments of the present disclosure, the second monomer is selected from methyl styrene or has a general structural formula represented by Formula II.

In some embodiments of the present disclosure, the silane coupling agent is a silane coupling agent containing a double bond structure and may be selected from any one or a combination of at least two of vinyltrimethoxysilane, vinyltriethoxysilane, vinylmethyldimethoxysilane, vinyldimethylethoxysilane, vinyltris(β-methoxyethoxy)silane, allyltrimethoxysilane, γ-methacryloxypropyltrimethoxysilane, γ-methacryloxypropyltriethoxysilane, γ-acryloxypropyltrimethoxysilane, styryltrimethoxysilane, or styryltriethoxysilane, optionally, γ-methacryloxypropyltrimethoxysilane (KH570).

In a third aspect, the present disclosure provides a microcapsule. The microcapsule includes the electrophoretic particle described in the first aspect.

In a fourth aspect, the present disclosure provides an electronic ink screen. The electronic ink screen includes the electrophoretic particle described in the first aspect or the microcapsule described in the third aspect.

The following examples are provided for further illustration.

Unless otherwise specified, the raw materials involved in the following specific examples of the present disclosure are all conventional materials in the art and can be purchased as commercially available products. Information on some raw materials is as follows:
Titanium dioxide (TiO₂): Particle diameter D50 of approximately 405 nm, purchased from DuPont, Ti-Pure® R-902+;
Silane coupling agent: KH570.

### Preparation Example

This preparation example provides a method for preparing a compound represented by the general formula of Formula II:

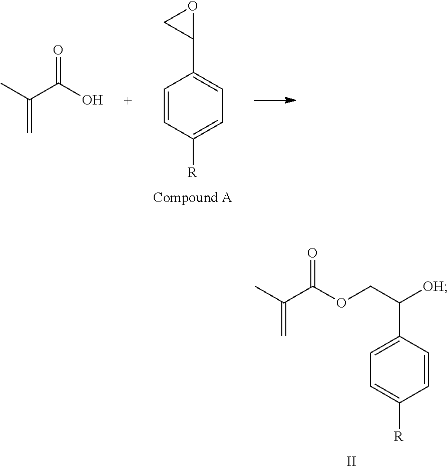

where R is H, methyl, methoxy or heptyloxy.

The preparation method is as follows:

Methacrylic acid and Compound A were mixed in anhydrous acetonitrile in a molar ratio of 1:1, with a total reactant concentration of 0.2 mol/L. The reactant was subjected to a reaction at 50 °C for 1 h under catalysis by p-toluenesulfonic acid. After the reaction was completed, the resulting reaction mixture was neutralized using sodium bicarbonate and extracted with ethyl acetate. The organic phase was collected, dried, and then the ethyl acetate was removed by rotary evaporation, and a compound having a structure represented by Formula II was obtained.

### Example 1

This example provides a method for preparing an electrophoretic particle, where the first monomer was lauryl methacrylate, the second monomer was α-methylstyrene, and the molar ratio (min) of the two was 7:3.

The preparation method is as follows:

(1) KH570, ethanol, and water were mixed in a ratio of 10:85:5, and acetic acid was added to adjust the pH to 4.5 to obtain a silane coupling agent reaction solution. 3.0 g of titanium dioxide was added to 15 mL of the silane coupling agent reaction solution, and the resulting reaction mixture was stirred at 100 rpm and reacted for 24 h. After the reaction was completed, the reaction mixture was centrifuged and washed with ethanol and deionized water three times each to obtain an intermediate product I.

(2) Under a nitrogen atmosphere, 2.0 g of intermediate product I was dispersed in 80 mL of xylene. Under stirring at 300 rpm, 10 mL of lauryl methacrylate, 0.12 g of benzoyl peroxide, and 0.04 g of dodecyl mercaptan were added and subjected to polymerization at 85 °C for 12 h. After the polymerization was completed, the precipitate was collected and dried under vacuum at 60 °C for 24 h to obtain an intermediate product II.

(3) Under a nitrogen atmosphere, the intermediate product II was dispersed in 50 mL of dimethyl ether. Under stirring at 300 rpm, 2 mL of α-methylstyrene, 0.3 mL of tert-butyl peroxy-2-ethylhexanoate, and 10 mg of 2,2,6,6-tetramethylpiperidine-1-oxyl radical were added, mixed, and subjected to a polymerization reaction at 110 °C for 12 h. After the reaction was completed, the precipitate was collected and extracted by Soxhlet extraction to remove impurity polymers.

(4) The resulting product was subjected to a high-temperature aging treatment at 100 °C for 96 h to obtain the electrophoretic particle.

### Example 2

This example provides a method for preparing an electrophoretic particle, where the first monomer was lauryl methacrylate, the second monomer was α-methylstyrene, and the molar ratio (m:n) of the two was 7:3.

The preparation method is as follows:

(1) An intermediate product was prepared according to the preparation method in Example 1.

(2) Under a nitrogen atmosphere, 2.0 g of intermediate product was dispersed in 100 mL of a mixed solvent of toluene/xylene (1:1). Under stirring at 300 rpm, 10 mL of lauryl methacrylate, 0.08 g of AIBN, and 0.02 g of copper bromide were added and subjected to polymerization at 75 °C for 4 h to obtain an intermediate product II.

(3) 2 mL of α-methylstyrene, 0.08 g of AIBN, and 0.05 g of dodecyl mercaptan were continuously fed, the temperature was raised to 85 °C, and the reaction mixture was subjected to a polymerization reaction for 20 h. After the reaction was completed, the precipitate was collected and extracted by Soxhlet extraction to remove impurity polymers.

(4) The resulting product was subjected to a high-temperature aging treatment at 150 °C for 72 h to obtain the electrophoretic particle.

### Example 3

This example provides a method for preparing an electrophoretic particle, where the first monomer was lauryl methacrylate, the second monomer was α-methylstyrene, and the molar ratio (m:n) of the two was 7:3.

The preparation method is as follows:

(1) An intermediate product was prepared according to the preparation method in Example 1.

(2) Under a nitrogen atmosphere, 2.0 g of intermediate product was dispersed in 100 mL of a mixed solvent of toluene/xylene (1:1). Under stirring at 300 rpm, 10 mL of lauryl methacrylate, 2 mL of α-methylstyrene, 0.16 g of AIBN, and 0.04 g of copper bromide were added and subjected to polymerization at 75 °C for 4 h, the temperature was then raised to 85 °C, and the reaction mixture was subjected to a polymerization reaction for 20 h. After the reaction was completed, the precipitate was collected and extracted by Soxhlet extraction to remove impurity polymers.

(3) The resulting product was subjected to a high-temperature aging treatment at 150 °C for 72 h to obtain the electrophoretic particle.

### Example 4

This example provides a method for preparing an electrophoretic particle, where the first monomer was lauryl methacrylate, the second monomer was α-methylstyrene, and the molar ratio (m:n) of the two was 7:3.

The preparation method is as follows:

(1) An intermediate product was prepared according to the preparation method in Example 1.

(2) Under a nitrogen atmosphere, 2.0 g of intermediate product was dispersed in 100 mL of a mixed solvent of toluene/xylene (1:1). Under stirring at 300 rpm, 10 mL of lauryl methacrylate, 2 mL of α-methylstyrene, 0.16 g of AIBN, and 0.04 g of copper bromide were added and subjected to polymerization at 80 °C for 24 h. After the reaction was completed, the precipitate was collected and extracted by Soxhlet extraction to remove impurity polymers.

(3) The resulting product was subjected to a high-temperature aging treatment at 150 °C for 72 h to obtain the electrophoretic particle.

### Examples 5 to 6

These examples provide a method for preparing an electrophoretic particle.

These examples differ from Example 1 in that in these examples, the first monomer lauryl methacrylate was replaced with stearyl acrylate (in Example 5) and 1-decene (in Example 6), respectively.

### Example 7

This example provides a method for preparing an electrophoretic particle.

This example differs from Example 1 in that in this example, the second monomer α-methylstyrene was replaced with an equimolar amount of a compound represented by the general formula of Formula II, where R was methyl.

### Examples 8 to 9

These examples provide a method for preparing an electrophoretic particle.

These examples differ from Example 1 in that in these examples, the molar ratio (m:n) of the first monomer lauryl methacrylate to the second monomer α-methylstyrene was 6:4 (in Example 8) and 8:2 (in Example 9), respectively.

### Comparative Examples 1 to 2

These comparative examples provide a method for preparing an electrophoretic particle.

These comparative examples differ from Example 1 in that in these comparative examples, the molar ratio (m:n) of the first monomer lauryl methacrylate to the second monomer α-methylstyrene was 4:6 (in Comparative Example 1) and 9.5:0.5 (in Comparative Example 2), respectively.

### Comparative Example 3

This comparative example provides a method for preparing an electrophoretic particle.

This comparative example differs from Example 1 in that in this comparative example, the second monomer α-methylstyrene was not added.

### Comparative Example 4

This comparative example provides a method for preparing an electrophoretic particle.

This comparative example differs from Example 1 in that in this comparative example, the first monomer lauryl methacrylate was not added.

### Comparative Example 5

This comparative example provides a method for preparing an electrophoretic particle.

This comparative example differs from Example 1 in that in this comparative example, the step of high-temperature aging was omitted.

### Performance Test

The electrophoretic particles provided by the above examples and comparative examples were tested for performance. The performance test was performed in the following specific methods.

(1) Microstructure: The electrophoretic particle from Example 1 was characterized for the microstructure. The results are as follows:

The FIGURE shows a TEM image of the electrophoretic particle obtained in Example 1 of the present disclosure. As can be seen from the FIGURE, the electrophoretic particle provided by the present disclosure features a polymer coating layer on the surface of the inorganic nanomaterial, with a coating rate of 100%.

### (2) Particle Dispersibility:

PDI: The polydispersity index (PDI) was calculated using the standard dynamic light scattering (DLS) method.

7-Day Sedimentation Rate: A 50 mL graduated cylindrical glass tube with a scale accuracy of 0.1 mL was selected. The prepared electrophoretic particles were dispersed in xylene at a solid content of 40%. Exactly 30 mL of the electrophoretic dispersion liquid was slowly injected into the glass tube, left to stand for 7 days, and observed for any stratification. The sedimentation rate was then calculated.

A simple electronic ink screen was prepared and tested for performance.

An ITO glass substrate measuring 60×50 mm was selected, with a size of area of 40×40 mm enclosed by frame glue and a thickness of 15 μm. After the electrophoretic dispersion liquid (xylene, with a 40% solid content) was injected, another glass substrate was used for encapsulation to prepare an electrophoretic device. With a driving voltage of 15 V, the device was tested for reflectivity and reliability. The test was performed in the following specific methods.

(3) Device Reflectivity: The reflectivity of the device was tested using a CA410 instrument.

(4) Device Reliability: A periodic driving voltage of 5 Hz was applied under normal temperature and humidity conditions to test the number of operational times the device could withstand. The test results are shown in Table 1.

TABLE 1

| | Particle Dispersibility | | | | |
|---|---|---|---|---|---|
| | | 7-Day | | | |
| | | Sedimentation | Device | Device | |
| Sample | PDI | Rate | Reflectivity | Reliability/Lifetime | |
| Example 1 | 0.1 | <1% | 54% | 1,000,000 | times |
| Example 2 | 0.1 | <2% | 52% | 1,000,000 | times |
| Example 3 | 0.1 | <2% | 52% | 1,000,000 | times |
| Example 4 | 0.2 | <3% | 48% | 700,000 | times |
| Example 5 | 0.2 | <3% | 45% | 700,000 | times |
| Example 6 | 0.2 | <3% | 46% | 600,000 | times |
| Example 7 | 0.1 | <1% | 55% | 1,000,000 | times |
| Example 8 | 0.1 | <1% | 51% | 1,000,000 | times |
| Example 9 | 0.1 | <1% | 52% | 1,000,000 | times |
| Comparative | 0.3 | <5% | 43% | 400,000 | times |
| Example 1 | | | | | |
| Comparative | 0.3 | <5% | 45% | 300,000 | times |
| Example 2 | | | | | |
| Comparative | 0.3 | <5% | 43% | 300,000 | times |
| Example 3 | | | | | |
| Comparative | 0.2 | <5% | 40% | 400,000 | times |
| Example 4 | | | | | |
| Comparative | 0.5 | <15% | 38% | 100,000 | times |
| Example 5 | | | | | |

As can be seen from the examples and performance tests, the electrophoretic particle provided by the present disclosure overcomes the drawback that agglomeration and sedimentation still occur after the modification and coating of inorganic nanoparticles, thereby enabling the electrophoretic particle to have excellent dispersion uniformity. Furthermore, during application, the electrophoretic particle exhibits outstanding dispersion stability, thereby preventing the electrophoretic particle from agglomeration and sedimentation caused by issues such as entanglement and/or bridging on the nanoparticle surfaces. Therefore, the reliability of the device is superior.

As can be seen from the comparison of Example 1 with Examples 5 to 6, selecting lauryl methacrylate as the flexible chain in the present disclosure can provide better performance.

As can be seen from the comparison of Examples 1 and 8 to 9 with Comparative Examples 1 to 2, in the present disclosure, maintaining the molar ratio of the first monomer to the second monomer within the range of 6:4 to 8:2 can ensure both excellent dispersion uniformity and dispersion stability of the electrophoretic particle.

As can be seen from the comparison of Example 1 with Comparative Examples 3 to 4, in the coating layer of the electrophoretic particle provided by the present disclosure, both the C8-C20 linear alkyl chain segments and the C6-C20 aryl chain segments are indispensable.

As can be seen from the comparison of Example 1 with Comparative Example 5, in the preparation method provided by the present disclosure, the final high-temperature aging step can further enhance the dispersion uniformity and dispersion stability of the electrophoretic particle.

Meanwhile, as can be seen from the performance test on the prepared simple electronic ink screens, the electronic ink screen prepared using the electrophoretic particle provided by the present disclosure has superior device reflectivity and device reliability.

Although the technical solutions of the present disclosure are described through the preceding embodiments, the present disclosure is not limited to the process steps described, which means that the implementation of the present disclosure does not necessarily depend on the process steps. It is to be understood by those skilled in the art that any improvements made to the present disclosure and equivalent replacements of raw materials adopted, additions of adjuvant ingredients, selections of specific manners, etc. in the present disclosure all fall within the scope of protection and disclosure of the present disclosure.

What is claimed is:

1. An electrophoretic particle, comprising an inorganic nanoparticle as a core and a copolymer coating layer disposed on at least part of a surface of the core, wherein the copolymer coating layer is bonded to the inorganic nanoparticle via a covalent bond, and the copolymer has p structural units represented by Formula I: 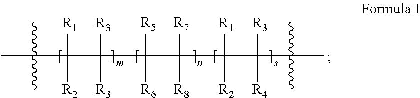
wherein
m+s>0, m×s=0, m and s are integers, n is a positive integer, and p≥1;
R₁ to R₄ comprise H, substituted or unsubstituted C1-C20 alkyl, or substituted or unsubstituted C1-C20 derivative alkyl, a group of the derivative comprises an ester group or an ether group, and at least one of R₁ to R₄ contains a C8-C20 linear alkyl chain segment;
R₅ to R₈ comprise H, substituted or unsubstituted C1-C5 alkyl, substituted or unsubstituted C6-C20 alkylaryl, or substituted or unsubstituted C6-C20 derivative alkylaryl, a group of the derivative comprises an ester group or an ether group, and at least one of R₅ to R₈ contains a C6-C20 aryl chain segment; and
“ [symbol] ” represents a linkage site.

2. The electrophoretic particle according to claim 1, wherein s=0.

3. The electrophoretic particle according to claim 1, wherein p=1.

4. The electrophoretic particle according to claim 1, wherein m>n.

5. The electrophoretic particle according to claim 4, wherein 6:4≤m:n≤8:2.

6. The electrophoretic particle according to claim 5, wherein m:n=7:3.

7. The electrophoretic particle according to claim 1, wherein any three of R₁ to R₄ are selected from H or C1-C4 alkyl, and only one of the three is C1-C4 alkyl.

8. The electrophoretic particle according to claim 7, wherein any one of R₁ to R₄ is —(CH₂)ₓ—COO—(CH₂)_{y}—CH₃, wherein x is selected from an integer of 0 to 4, and y is selected from an integer of 7 to 19.

9. The electrophoretic particle according to claim 8, wherein R₁ and R₂ are H, R₃ is —CH₃, and R₄ is —COO—(CH₂)₁₁—CH₃.

10. The electrophoretic particle according to claim 1, wherein any three of R₅ to R₈ are selected from H or C1-C4 alkyl, and only one of the three is C1-C4 alkyl.

11. The electrophoretic particle according to claim 10, wherein any one of R₅ to R₈ is —C6H₅ or —(CH₂)_{c}—COO—R₉, wherein c is selected from an integer of 0 to 4, R₉ is selected from substituted or unsubstituted C6-C20 alkylaryl, and a substituted group comprises a hydroxyl group, a carboxyl group, an alkyl group or an alkoxy group.

12. The electrophoretic particle according to claim 11, wherein R₅ and R₆ are H, R₇ is —CH₃, and R₈ is —C6H₅ or —COO—CH₂—CH(OH)—C6H₄—R, wherein R is selected from H, —CH₃, —OCH₃ or —O—(CH₂)₆—CH₃.

13. The electrophoretic particle according to claim 12, wherein R₈ is —COO—CH₂—CH(OH)—C6H₄—R, wherein R is selected from H, —CH₃, —OCH₃ or —O—(CH₂)₆—CH₃.

14. The electrophoretic particle according to claim 1, wherein the copolymer has a relative molecular weight of 1000-200000;
and/or a coating rate of the copolymer coating layer on the core is >99.9%.

15. The electrophoretic particle according to claim 1, wherein the inorganic nanoparticle comprises any one or a combination of at least two of titanium dioxide, zirconium oxide, zinc oxide, antimony trioxide or silicon dioxide;
and/or the inorganic nanoparticle has a particle diameter of 50-1000 nm.

16. A method for preparing the electrophoretic particle according to claim 1, comprising:
(1) subjecting an inorganic nanoparticle and a silane coupling agent to a coupling reaction to obtain an intermediate product; and
(2) subjecting the intermediate product to a free radical copolymerization reaction with a first monomer and a second monomer to obtain the electrophoretic particle;
wherein the first monomer carries R₁ to R₄ groups, and the second monomer carries R₅ to R₈ groups.

17. The preparation method according to claim 16, further comprising: (3) performing a high-temperature aging treatment after the free radical reaction;
wherein the high-temperature aging treatment is performed at a temperature of 100-150 °C for 48-96 h.

18. The preparation method according to claim 16, wherein the first monomer is selected from any one or a combination of at least two of lauryl (meth)acrylate, myristyl (meth)acrylate, cetyl (meth)acrylate, stearyl (meth)acrylate, 1-decene, or an olefin compound having 11-21 carbon atoms;
and/or the second monomer is selected from styrene, methyl styrene, cinnamene, phenylbutenoid, vinylnaphthalene or benzyl methacrylate, or has a general structural formula represented by Formula II: 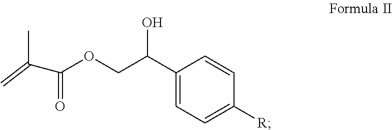
wherein R is selected from H, —CH₃, —OCH₃, or —O—(CH₂)₆—CH₃;
and/or a molar amount of the first monomer accounts for 60%-80% of a total molar amount of the first monomer and the second monomer.

19. A microcapsule, comprising an electrophoretic particle, wherein the electrophoretic particle comprises:
an inorganic nanoparticle as a core and a copolymer coating layer disposed on at least part of a surface of the core, wherein the copolymer coating layer is bonded to the inorganic nanoparticle via a covalent bond, and the copolymer has p structural units represented by Formula I: 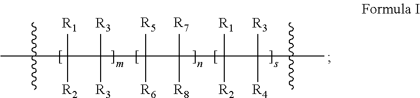
wherein
m+s>0, m×s=0, m and s are integers, n is a positive integer, and p≥1;
R₁ to R₄ comprise H, substituted or unsubstituted C1-C20 alkyl, or substituted or unsubstituted C1-C20 derivative alkyl, a group of the derivative comprises an ester group or an ether group, and at least one of R₁ to R₄ contains a C8-C20 linear alkyl chain segment;
R₅ to R₈ comprise H, substituted or unsubstituted C1-C5 alkyl, substituted or unsubstituted C6-C20 alkylaryl, or substituted or unsubstituted C6-C20 derivative alkylaryl, a group of the derivative comprises an ester group or an ether group, and at least one of R₅ to R₈ contains a C6-C20 aryl chain segment; and
“ [symbol] ” represents a linkage site.

20. An electronic ink screen, comprising a microcapsule, wherein the microcapsule comprises an electrophoretic particle, and the electrophoretic particle comprises:
an inorganic nanoparticle as a core and a copolymer coating layer disposed on at least part of a surface of the core, wherein the copolymer coating layer is bonded to the inorganic nanoparticle via a covalent bond, and the copolymer has p structural units represented by Formula I: 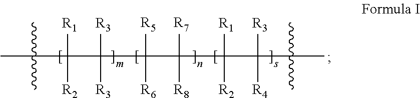
wherein
m+s>0, m×s=0, m and s are integers, n is a positive integer, and p>1;
R₁ to R₄ comprise H, substituted or unsubstituted C1-C20 alkyl, or substituted or unsubstituted C1-C20 derivative alkyl, a group of the derivative comprises an ester group or an ether group, and at least one of R₁ to R₄ contains a C8-C20 linear alkyl chain segment;
R₅ to R₈ comprise H, substituted or unsubstituted C1-C5 alkyl, substituted or unsubstituted C6-C20 alkylaryl, or substituted or unsubstituted C6-C20 derivative alkylaryl, a group of the derivative comprises an ester group or an ether group, and at least one of R₅ to R₈ contains a C6-C20 aryl chain segment; and
“ [symbol] ” represents a linkage site.
